(19) United States
(12) Patent Application Publication
(10) Pub. No.: US 2007/0289080 A1
(43) Pub. Date: Dec. 20, 2007

(54) Windscreen Wiper System

(76) Inventor: Burak Barlas, Baden-Baden (DE)

Correspondence Address: MICHAEL BEST & FRIEDRICH LLP, 100 EAST WISCONSIN AVENUE, MILWAUKEE, WI, 53202, US

(21) Appl. No.: 10/587,635

(22) PCT Filed: Jan. 14, 2005
(86) PCT No.: PCT/EP05/50151

§ 371 Date: Apr. 18, 2007

(30) Foreign Application Priority Data
Feb. 2, 2004 (DE) 10 2004 005 068.6

(51) Int. Cl. B60S 1/34

(52) U.S. Cl. 15/250.34

(57) ABSTRACT

The invention relates to a windshield wiper device, in particular for a motor vehicle, comprising a securing part (10), which is used to secure a wiper arm to a wiper shaft (13). Manufacturing tolerances in the windshield wiper device, in particular in the wiper arms and the vehicle body, lead to a deviation of the actual position of the wiper arm from its target position. The aim of the invention is balancing the manufacturing tolerances in the region of the wiper arm. According to the invention, the position of the wiper arm can be adjusted in a transversal manner in relation to the wiper shaft (13) by means of the securing part (10).

The invention relates to a windshield wiper device, in particular for a motor vehicle, with a securing part for securing a wiper arm to the wiper shaft.

Manufacturing tolerances for the windshield wiper device, particularly in the case of the wiper arms and the vehicle body, require a deviation of the actual position of the wiper arm from its target position. These deviations lead to undesired narrow points between the wiper arms and the body as well as to collisions of the wiper arms with the body or the window. In addition, the entire design of the vehicle is negatively impacted by these deviations because the required distances between the wiper arm and the body cannot be adhered to due to the addition of tolerances. These tolerances cannot be compensated for when assembling the wiper arms.

The aim of the invention is improving a windshield wiper device of the type cited at the outset such that in the future manufacturing tolerances in the region of the wiper arm can be compensated for.

The invention attains the stated objected by a windshield wiper device of the type cited at the outset in which, according to the invention, the position of the wiper arm can be in a adjusted in a transversal manner in relation to the wiper shaft by means of the securing part. Consequently, in the future, when assembling the wiper arm manufacturing tolerances can be compensated for. Because of this possibility for compensation, the undesired narrow points and collisions between the wiper arm and the body or the window are avoided. In addition, design requirements can be met precisely with the windshield wiper device in accordance with the invention.

In another development of the invention, the securing part can have a lower part and an upper part that can be displaced relative thereto. In this way, the windshield wiper device in accordance with the invention can be realized structurally in a very simple and therefore cost-effective manner. The lower part can be mounted expediently on the wiper shaft, whereas the wiper arm is attached to the upper part.

If the lower part and the upper part are provided with grooves that can engage in one another, the upper part and the lower part can be displaced relative to one another along the grooves, whereby the position of the wiper arm can be continuously adjusted in a transversal manner in relation to the wiper shaft. In addition, the grooves also facilitate a positively engaged connection for the transmission torque between the lower part and the upper part, whereby the transmission of torque takes place transverse to the grooves.

In a preferred embodiment, the upper part can have a recess to accommodate the lower part. Then the lower part can be sunk at least partially in the upper part. Firstly, this structural measure saves installation space and secondly creates a further positive engagement between the upper part and the lower part. Due to the positive engagement, external surfaces of the lower part are in contact with interior surfaces of the upper part so that a transmission of torque can also occur through the external surfaces of the lower part and the interior surfaces of the upper part, if the positive engagement of the grooves is not sufficient.

The upper part can advantageously have an elongated hole for inserting the wiper shaft. Because of the elongated hole, positioning the upper part that accommodates the wiper arm is possible transverse to the wiper shaft. As a result of the fact that the wiper shaft can be inserted through the upper part, the upper part and the wiper shaft can be screwed together, for example by a nut.

So that the wiper shaft can be inserted through the upper part, the lower part can have a hole for inserting the wiper shaft.

So that the upper part can be placed on the conical end area of the wiper shaft in an optimal manner, the hole in the lower part can also be conical.

In a preferred embodiment, the upper part can feature another recess to accommodate a nut or a screw head. Because of the recess, the nut or the screw head can be sunk in the upper part, thereby saving installation space.

One exemplary embodiment of the invention is explained in greater detail in the following on the basis of the enclosed drawings.

The drawings show the following in detail:

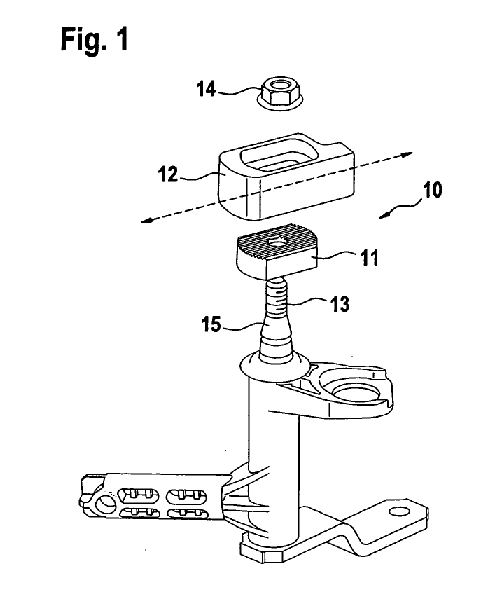

FIG. 1 A perspective exploded depiction of the securing part and the wiper shaft;

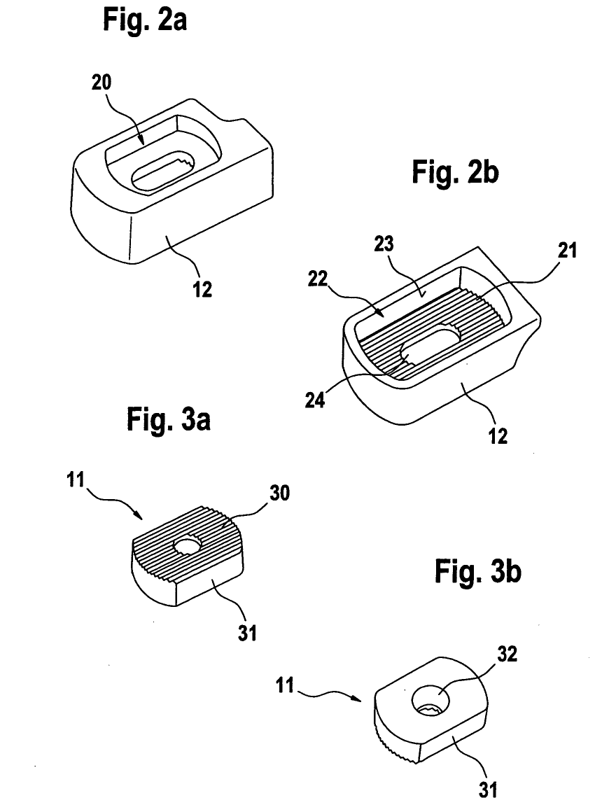

FIG. 2a A perspective view from above of the upper part;

FIG. 2b A perspective view from below of the upper part;

FIG. 3a A perspective view from above of the lower part;

FIG. 3b A perspective view from below of the lower part;

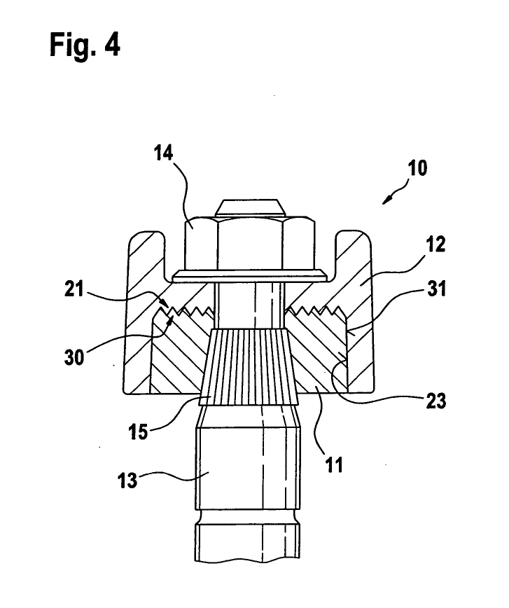

FIG. 4 A sectional view through a mounted securing part;

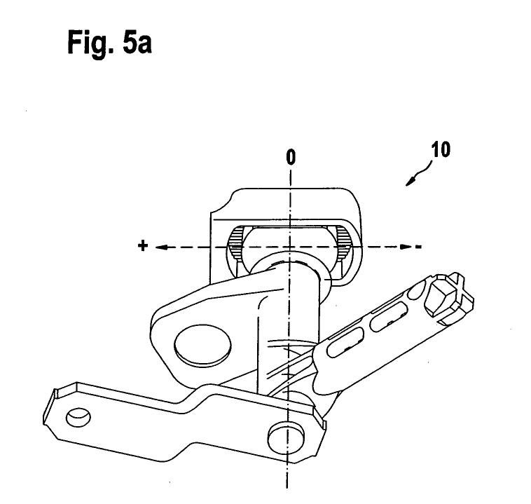

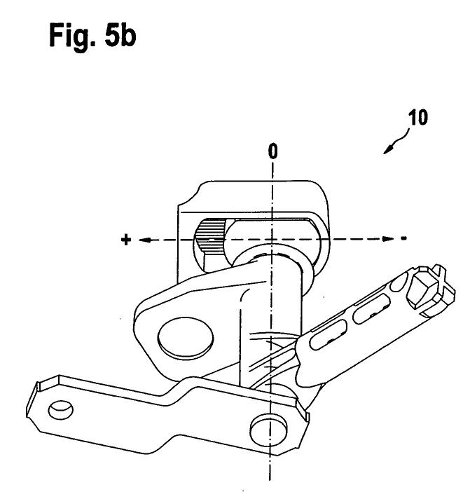

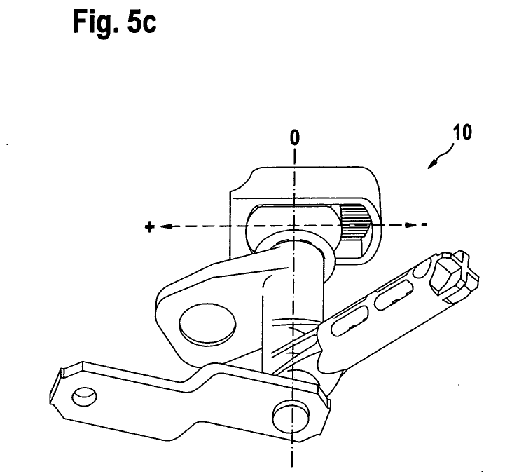

FIG. 5a A perspective view from below of the mounted securing part in a first position;

FIG. 5b A perspective view from below of the mounted securing part in a second position;

FIG. 5c A perspective view from below of the mounted securing part in a third position.

FIG. 1 shows a securing part 10, comprised of a lower part 11 and an upper part 12. The lower part 11 and the upper part 12 are adjacent to one another, and can be placed on a wiper shaft 13. The wiper shaft 13 is provided with an external screw thread, on which a nut 14 is screwed to secure the securing part 10.

The upper part 12 has a recess 20 on its upper side (see FIG. 2a) in which the nut 14 is sunk at least partially.

The upper part 12 is provided with grooves 21 on its lower side (see FIG. 2b), which engage (see FIG. 4) in the grooves 30 of the lower part 11 (see FIG. 3a). As a result, the upper part 12 can be displaced continuously relative to the lower part 11 along the grooves 21 and 30, whereby the position of a wiper arm (not shown here in more detail) can be continuously adjusted transverse to the wiper shaft 13. In addition, the grooves 21 and 30 guarantee a positively engaged connection for the transmission of torque between the lower part 11 and the upper part 12. The torque is transmitted transverse to the grooves (FIG. 4).

The upper part 12 is also provided with a recess 22 on its lower side to accommodate the lower part 11. Consequently, the lower part 11 can be sunk at least partially in the upper part 12. The recess 22 forms another positive engagement of the lower part 11 with the upper part 12. As a result of the positive engagement, external surfaces 31 of the lower part 11 come into contact with interior surfaces 23 of the upper part 12 (see FIGS. 2b, 3a, 3b and 4). Therefore, the torque can also be transmitted through the external surfaces 31 and internal surfaces 23, if the positive engagement of the grooves 21 and 30 is not sufficient to transmit the torque (FIG. 4).

The upper part 12 is provided with an elongated hole 24 through which the wiper shaft 13 is inserted. The elongated hole 24 facilitates positioning of the upper part 12 transverse to the wiper shaft 13. The lower part 11 has a hole 32 through which the wiper shaft 13 can be inserted.

The wiper shaft 13 features a conical area 15 to which the hole 32 of the lower part 11 is adapted (see FIGS. 1 and 4).

FIGS. 5a, 5b and 5c show various positions of the securing part 10 that has been mounted on the wiper shaft 13. In FIG. 5a, the securing part 10 is situated with its center point on the wiper shaft 13. In FIGS. 5b and 5c, the securing part 10 is mounted on the wiper shaft 13 in the two outermost positions, respectively.

1. Windshield wiper device, for a motor vehicle, comprising a securing part (10), which is used to secure a wiper arm to a wiper shaft (13), characterized in that the position of the wiper arm can be adjusted in a transverse manner in relation to the wiper shaft (13) by means of the securing part (10).

2. Windshield wiper device according to claim 1, characterized in that securing part (10) has a lower part (11) and an upper part (12) that can be displaced relative thereto.

3. Windshield wiper device according to claim 2, characterized in that the lower part (11) and the upper part (12) are provided with grooves (21, 30) that can engage in one another.

4. Windshield wiper device according to claim 2, characterized in that the upper part (12) has a recess (22) to accommodate the lower part (11).

5. Windshield wiper device according to claim 2, characterized in that the upper part (12) has an elongated hole (24) for inserting the wiper shaft (13).

6. Windshield wiper device according to claim 2, characterized in that the lower part (11) has a hole (32) for inserting the wiper shaft (13).

7. Windshield wiper device according to claim 6, characterized in that the hole (32) in the lower part (11) is conical.

8. Windshield wiper device according to claim 2, characterized in that the upper part (12) features another recess (20) to accommodate a nut (14) or a screw head.

9. Windshield wiper device according to claim 3, characterized in that the upper part (12) has a recess (22) to accommodate the lower part (11).

10. Windshield wiper device according to claim 3, characterized in that the upper part (12) has an elongated hole (24) for inserting the wiper shaft (13).

11. Windshield wiper device according to claim 4, characterized in that the upper part (12) has an elongated hole (24) for inserting the wiper shaft (13).

12. Windshield wiper device according to claim 3, characterized in that the lower part (11) has a hole (32) for inserting the wiper shaft (13).

13. Windshield wiper device according to claim 4, characterized in that the lower part (11) has a hole (32) for inserting the wiper shaft (13).

14. Windshield wiper device according to claim 5, characterized in that the lower part (11) has a hole (32) for inserting the wiper shaft (13).

15. Windshield wiper device according to claim 3, characterized in that the upper part (12) features another recess (20) to accommodate a nut (14) or a screw head.

16. Windshield wiper device according to claim 4, characterized in that the upper part (12) features another recess (20) to accommodate a nut (14) or a screw head.

17. Windshield wiper device according to claim 5, characterized in that the upper part (12) features another recess (20) to accommodate a nut (14) or a screw head.

18. Windshield wiper device according to claim 6, characterized in that the upper part (12) features another recess (20) to accommodate a nut (14) or a screw head.

19. Windshield wiper device according to claim 7, characterized in that the upper part (12) features another recess (20) to accommodate a nut (14) or a screw head.
